(19) United States
(12) Patent Application Publication
(10) Pub. No.: US 2003/0201345 A1
(43) Pub. Date: Oct. 30, 2003

(54) Watering hose having woven polyethylene fabric layer

(76) Inventor: In Seon Jeong, Seoul (KR)

Correspondence Address: DARBY & DARBY P.C., Post Office Box 5257, New York, NY, 10150-5257, US

(21) Appl. No.: 10/136,657

(22) Filed: Apr. 30, 2002

(51) Int. Cl. B05B 15/00

(52) U.S. Cl. 239/542

(57) ABSTRACT

Disclosed is a watering hose having a woven polyethylene fabric layer, which has a construction capable of efficiently transferring and spraying water of high pressure while the watering hose is very thin, thereby reducing price of the watering hose, and capable of preventing the watering hose from moving even without a separate fixing member. The watering hose has a plurality of spray apertures formed through a tubular body of the watering hose. The watering hose is made by overlapping and attaching side ends of a preform sheet on and to each other. The preform sheet has polyethylene multi-layers, which comprise at least one woven polyethylene fabric layer and polyethylene coating layers. The polyethylene coating layers form both outer surfaces of the polyethylene multi-layers.

### BACKGROUND OF THE INVENTION

1. Field of the Invention

The present invention relates to a watering hose, and more particularly to a watering hose having a woven polyethylene fabric layer, which has a construction capable of efficiently transferring and spraying water of high pressure while the watering hose is very thin, thereby reducing price of the watering hose, and capable of preventing the watering hose from moving even without a separate fixing member.

2. Description of the Prior Art

As generally known in the art, a watering hose has a plurality of spray apertures formed through and along an outer surface of the watering hose. In the watering hose, water at high pressure is transferred through the watering hose while being evenly supplied through the spray apertures to crops, grass, etc.

The watering hose as described above is required to have high-pressure resistance and flexibility. The watering hose has a multi-layer construction including a plurality of resin layers and fabric layers alternately overlapped on each other. In this case, an inner surface of each fabric layer is fixedly attached to an outer surface of a resin layer inside of the fabric layer through heating which utilizes saturated vapor as a heating medium.

Meanwhile, the watering hose has a hollow cylindrical shape. Therefore, when the watering hose is placed on the ground and water at high pressure is spray through the cylindrical wall of the watering hose, the watering hose shakes and twists due to the high pressure of the water transferred through the watering hose, so as to make it difficult to evenly water desired area which needs watering. Therefore, in a conventional watering system, a plurality of supporters, each of which has a clamp disposed at an upper end of the supporter, are stuck into and fixed on the ground, and a conventional watering hose is fixed by the clamps of the supporters, so that the watering hose is prevented from moving.

However, since the conventional watering hose has thick multiple resin layers, such as rubber and poly vinyl chloride (PVC), and fabric layers inserted between each two resin layers, the entire thickness of the conventional watering hose is considerably large, thereby increasing cost of material, deteriorating flexibility of the watering hose, complicating the process of forming the watering hose, and deteriorating the productivity.

Further, in the case of employing supporters as described above in order to prevent the watering hose from moving, the supporters which are relatively expensive increase the expense for the conventional watering hose. Moreover, since a user has to stick the supporters into the ground and assemble the watering hose on the clamps of the supporters one by one, it takes much time in installing the watering hose in a field which needs watering.

Moreover, since the spray apertures formed through the cylindrical wall of the conventional watering hose have the same uniform size, water sprayed at a uniform pressure through the apertures is not distributed to a broad area but concentrated to a limited area. Therefore, it is difficult to uniformly supply an adequate quantity of water necessary for the crops, etc. Moreover, since the area which can be watered by a single watering hose is too small, a relatively large number of conventional watering hoses must be installed in a unit area.

### SUMMARY OF THE INVENTION

Accordingly, the present invention has been made to solve the above-mentioned problems occurring in the prior art, and an object of the present invention is to provide a watering hose having a woven polyethylene fabric layer, which can efficiently transfer and spray water of high pressure while the watering hose is very thin, thereby reducing cost of material, improving flexibility of the watering hose, simplifying and facilitating the process of forming the watering hose, and improving the productivity.

It is another object of the present invention to provide a watering hose having a woven polyethylene fabric layer, which has a flat seating member formed along a portion of a tubular body of the watering hose, so as to prevent the watering hose from moving even without a separate fixing member and simplify the labor of installing the watering hose on a field to be watered.

It is another object of the present invention to provide a watering hose having a woven polyethylene fabric layer, in which spray apertures whose sizes are different in the circumferential direction are formed through the watering hose, so that water is sprayed through the different spray apertures at different pressures, thereby enabling a small number of watering hoses to evenly water a broad area.

In order to accomplish this object, there is provided a watering hose having a plurality of spray apertures formed through a tubular body of the watering hose, the watering hose being made by overlapping and attaching side ends of a preform sheet on and to each other, the preform sheet having polyethylene multi-layers, the polyethylene multi-layers comprising at least one woven polyethylene fabric layer and polyethylene coating layers, the polyethylene coating layers forming both outer surfaces of the polyethylene multi-layers.

The preform sheet has watertight side ends which are formed by attaching watertightening means to exposed side ends of the woven polyethylene fabric layer of the preform sheet, thereby preventing a sweating phenomenon through the woven polyethylene fabric layer.

Further, it is preferred that the watering hose further includes a flat member formed at a portion of the tubular body of the watering hose, which extends in a longitudinal direction of the watering hose.

Also, it is more preferable that the spray apertures formed through a tubular body of the watering hose have diameters which are different according to circumferential locations of the spray apertures.

### BRIEF DESCRIPTION OF THE DRAWINGS

The above and other objects, features and advantages of the present invention will be more apparent from the following detailed description taken in conjunction with the accompanying drawings, in which:

FIG. 1 is a partly cut-out perspective view of a preform sheet for forming a watering hose having a woven polyethylene fabric layer according to an embodiment of the present invention;

FIG. 2 is a partly cut-out perspective view of a watering hose made of the preform sheet shown in FIG. 1;

FIG. 3 is a partly cut-out perspective view of a preform sheet for forming a watering hose having a woven polyethylene fabric layer according to another embodiment of the present invention;

FIG. 4 is a partly cut-out perspective view of a watering hose made of the preform sheet shown in FIG. 3;

FIG. 5 is a sectional view of a portion of a preform sheet for forming a watering hose having a woven polyethylene fabric layer according to another embodiment of the present invention;

FIG. 6 is a partly cut-out perspective view of a watering hose made of the preform sheet shown in FIG. 5;

FIG. 7 is a transverse sectional view of the watering hose shown in FIG. 2, which illustrates a sweating phenomenon;

FIGS. 8 to 11 are partially enlarged sectional views of watering hoses according to other embodiments of the present invention;

FIGS. 12A to 15B are sectional views of preform sheets and watering hoses according to other embodiments of the present invention;

FIG. 16 is a partly cut-out perspective view of a watering hose according to another embodiment of the present invention;

FIG. 17 is a transverse sectional view of the watering hose shown in FIG. 16, which shows the state when the watering hose is used; and

FIG. 18 is a partly cut-out perspective view of a watering hose according to another embodiment of the present invention.

### DETAILED DESCRIPTION OF THE PREFERRED EMBODIMENTS

Hereinafter, a watering hose having a woven polyethylene fabric layer according to preferred embodiments of the present invention will be described with reference to the accompanying drawings.

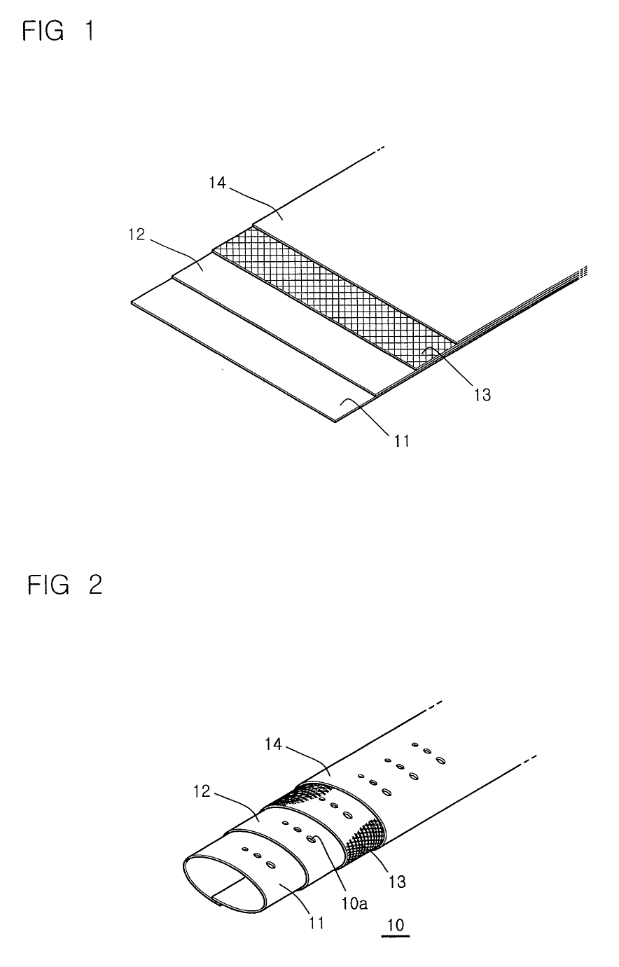

FIGS. 1 and 2 show a preform sheet for forming a watering hose having a woven polyethylene fabric layer according to an embodiment of the present invention and the watering hose made of the preform sheet.

As shown, a watering hose 10 according to an embodiment of the present invention is made by overlapping and attaching side ends of a preform sheet on and to each other in a cylindrical shape. In this case, the preform sheet has polyethylene multi-layers 12 to 14 including a woven polyethylene fabric layer 13. The preform sheet may further include a polyethylene protective film 11 overlapped on and attached to an outer surface of the polyethylene multi-layers 12 to 14.

In the polyethylene multi-layers 12 to 14, the woven polyethylene fabric layer 13 and the polyethylene coating layers 12 and 14 are alternately overlapped on each other, and both surfaces of the woven polyethylene fabric layer 13 are covered with the polyethylene coating layers 12 and 14, so as to prevent the woven polyethylene fabric layer 13 from being exposed.

In manufacturing the polyethylene multi-layers 12 to 14 described above, the woven polyethylene fabric layer 13 has a melting point higher than that of the polyethylene coating layers 12 and 14, so that the woven polyethylene fabric layer 13 and the polyethylene coating layers 12 and 14 can be tightly attached to each other. This difference between melting points of the multiple layers prevents each layer from coming off from adjacent layers, which may easily happen when the layers have the same melting point.

The polyethylene protective film 11 overlapped on and attached to the outer surface of the polyethylene coating layer 12 also has a melting point higher than that of the polyethylene coating layer 12, so that the polyethylene protective film 11 can be tightly attached to the polyethylene coating layer 12.

Further, when the watering hose 10 is manufactured by means of the preform sheet having the construction described above, the side ends of the preform sheet are overlapped on and attached to each other in a hose shape or a cylindrical shape in such a manner that the polyethylene protective film 11 serves as an inner surface of the watering hose, so that the watering hose 10 has a strength capable of sufficiently enduring the high pressure of water transferred through the watering hose 10. It goes without saying that, in addition to the polyethylene protective film 11 attached to the outer surface of the polyethylene coating layer 12, the watering hose 10 may further include a polyethylene protective film having a melting point higher than that of the polyethylene coating layer 14, which is attached on an outer surface of the outermost polyethylene coating layer 14, in order to increase the strength of the watering hose 10. A reference numeral 10a not described above designates spray apertures.

The watering hose formed by a preform sheet having the construction described above, which includes a woven polyethylene fabric layer having high rupture-resistance, can be efficiently used in transferring and spraying water at high pressure. Moreover, in comparison with the conventional watering hose having a plurality of resin layers and fabric layers, the watering hose described above has remarkably smaller thickness, reduced cost of material, improved flexibility, simplified and facilitated process of forming the watering hose, and improved productivity. In this case, it goes without saying that these effects can also be achieved by the preform sheet including only the polyethylene multi-layers without the polyethylene protective film.

It is preferred that the polyethylene coating layers 12 and 14 are made from low density polyethylene (LDPE) whose density is about 0.91 g/cm², since the polyethylene coating layers 12 and 14 mainly serve to coat both outer surfaces of the polyethylene coating layer 13. Further, it is preferred that the polyethylene protective film 11 is made from high density polyethylene (HDPE) whose density is about 0.941 to 0.965 g/cm². The high density polyethylene has a tensile strength of 330 to 340 kg/cm², which is 2.5 times as large as that of the low density polyethylene, so that the thin polyethylene protective film 11 can sufficiently endure the pressure of the water transferred and sprayed through the watering hose 10. Kinds of the polyethylene materials are selected in the same manner as described above for other polyethylene coating layers and polyethylene protective films in other embodiments of the present invention, which will be described later.

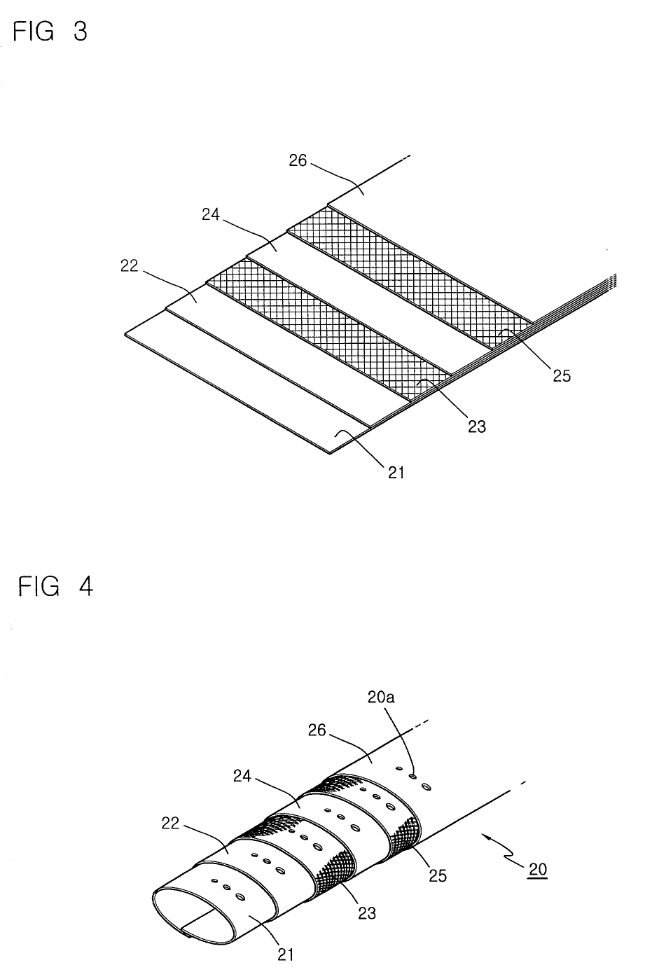

FIG. 3 is a constructional view of a preform sheet for forming a watering hose having a woven polyethylene fabric layer according to another embodiment of the present invention, and FIG. 4 is a perspective view of a watering hose made of the preform sheet shown in FIG. 3. As shown, the preform sheet for forming a watering hose 20 according to another embodiment of the present invention includes polyethylene multi-layers 22 to 26, which include at least two woven polyethylene fabric layers 23 and 25, and a polyethylene protective film 21 overlapped on and attached to the polyethylene multi-layers. A reference numeral 20a designates spray apertures.

The polyethylene multi-layers 22 to 26 include a plurality of woven polyethylene fabric layers 23 and 25 and polyethylene coating layers 22, 24, and 26 overlapped on and attached to each other in which the polyethylene coating layers 22 and 26 form both outermost layers of the polyethylene multi-layers, so as to prevent the woven polyethylene fabric layer 23 and 25 from being exposed.

In manufacturing the polyethylene multi-layers 22 to 26 described above, the woven polyethylene fabric layers 23 and 25 have melting points higher than those of the polyethylene coating layers 22, 24, and 26, so that the woven polyethylene fabric layers 23 and 25 and the polyethylene coating layers 22, 24, and 26 can be tightly attached to each other.

The polyethylene protective film 21 overlapped on and attached to the outer surface of the polyethylene coating layer 22 also has a melting point higher than that of the polyethylene coating layer 22, so that the polyethylene protective film 21 can be tightly attached to the polyethylene coating layer 22.

Further, when the watering hose 20 is manufactured by means of the preform sheet having the construction described above, the side ends of the preform sheet are overlapped on and attached to each other in a hose shape or a cylindrical shape in such a manner that the polyethylene protective film 21 serves as an inner surface of the watering hose, so that the watering hose 20 has a strength capable of sufficiently enduring the high pressure of water transferred through the watering hose 20. It goes without saying that, in addition to the polyethylene protective film 21 attached to the outer surface of the polyethylene coating layer 22, the watering hose 20 may further include a polyethylene protective film having a melting point higher than that of the polyethylene coating layer 26, which is attached on an outer surface of the outermost polyethylene coating layer 26, in order to increase the strength of the watering hose 20.

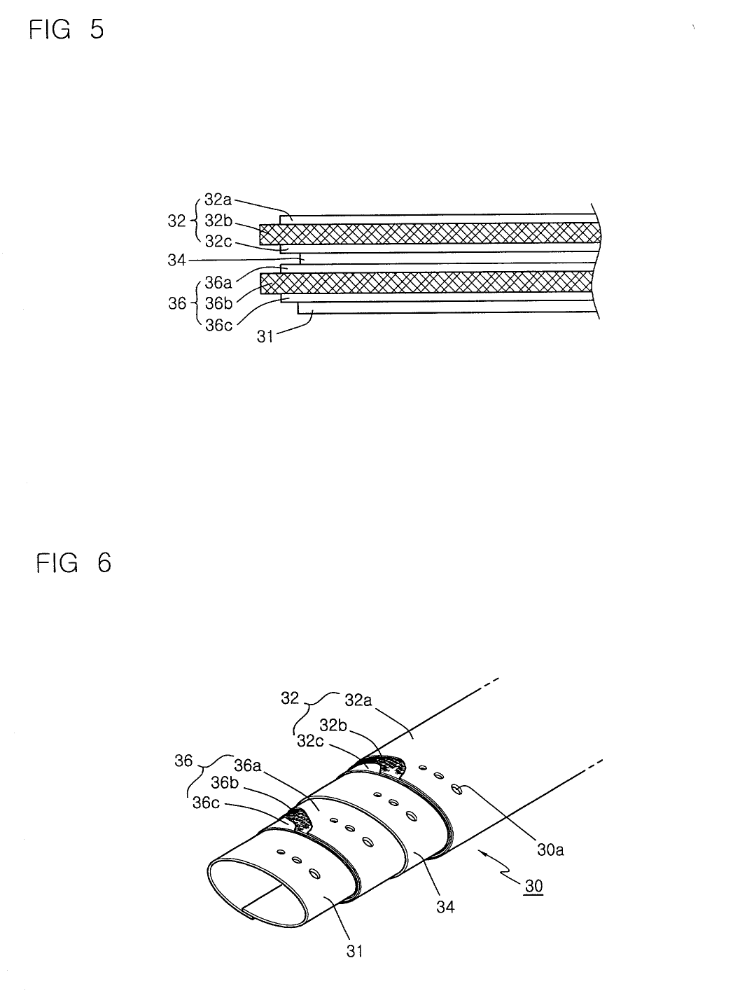

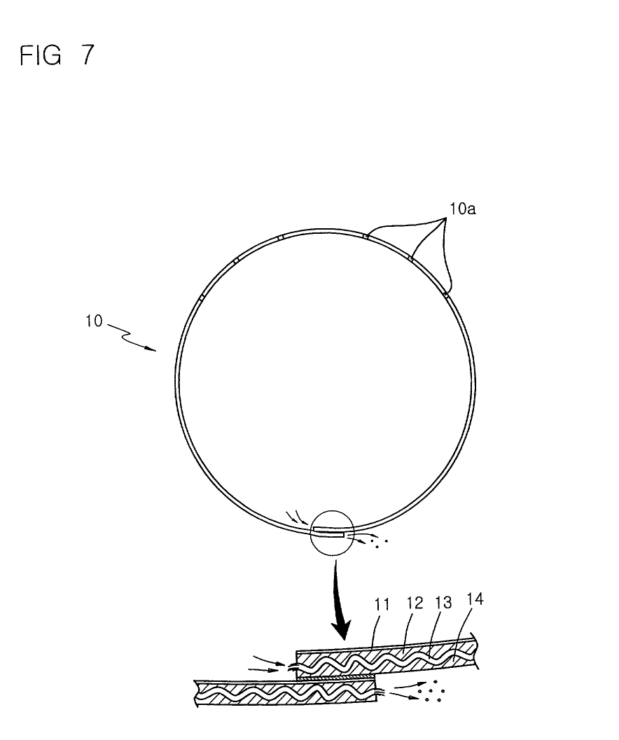

FIG. 5 is a side sectional view of preform sheet for forming a watering hose having a woven polyethylene fabric layer according to another embodiment of the present invention, and FIG. 6 is a perspective view of a watering hose made of the preform sheet shown in FIG. 5. A reference numeral 30a designates spray apertures.

As shown, a watering hose 30 according to another embodiment of the present invention is made of a preform sheet which includes a plurality of tarpaulin layers 32 and 36 including a woven polyethylene fabric layer, a watertight bonding film 34 disposed between the tarpaulin layers 32 and 36, and a polyethylene protective film 31 overlapped on and attached to an outer surface of the tarpaulin layers.

Each of the tarpaulin layers 32 and 36 includes a woven polyethylene fabric layer 32b and 36b and two polyethylene coating layers 32a, 32c, 36a, and 36c attached to both surfaces of the woven polyethylene fabric layers 32b and 36b. In this case, each of the polyethylene coating layers 32a, 32c, 36a, and 36c has a melting point lower than that of the woven polyethylene fabric layers 32b and 36b, so that the layers are tightly attached to each other.

Further, the watertight bonding film 34 interposed between the tarpaulin layers 32 and 36 has a melting point higher than that of the adjacent polyethylene coating layers 32c and 36a, so that the tarpaulin layers 32 and 36 are tightly attached to each other by means of the watertight bonding film 34. For example, the watertight bonding film 34 may be preferably made from high density polyethylene having a high melting point while the adjacent polyethylene coating layers 32c and 36a are made from low density polyethylene.

The polyethylene protective film 31 overlapped on and attached to an outer surface of the tarpaulin layers 32 and 36 attached to each other by means of the watertight bonding film 34, that is, an outer surface of the polyethylene coating layer 36c, also has a melting point higher than that of the polyethylene coating layer 36c, so that the polyethylene protective film 31 can be tightly attached to the polyethylene coating layer 36c.

Further, when the watering hose 30 is manufactured by means of the preform sheet having the construction described above, side ends of the preform sheet are overlapped on and attached to each other in a hose shape or a cylindrical shape in such a manner that the polyethylene protective film 31 serves as an inner surface of the watering hose, so that the watering hose 30 has a strength capable of sufficiently enduring the high pressure of water transferred through the watering hose 30. It goes without saying that, in addition to the polyethylene protective film 31 attached to the outer surface of the polyethylene coating layer 36c, the watering hose 30 may further include a polyethylene protective film having a melting point higher than that of the polyethylene coating layer 32a, which is attached on an outer surface of the outermost polyethylene coating layer 32a, in order to increase the strength of the watering hose 30.

In the meantime, when a watering hose is manufactured by means of the preform sheet having the construction described above, the woven polyethylene fabric layer 13 forming a core of the preform sheet may be exposed along both side ends of the preform sheet. In this case, there may happen a so-called sweating phenomenon, in which the water transferred through the watering hose leaks through the exposed side ends of the woven polyethylene fabric layer 13.

In detailed description, the woven polyethylene fabric layer 13 inserted as a reinforcing core in the middle of the preform sheet is made by weaving a plurality of fine filaments as longitudinal filaments and latitudinal filaments. Therefore, in a state where both surfaces of the woven polyethylene fabric layer 13 are coated with the polyethylene coating layers 12 and 14, the water cannot pass through the polyethylene coating layers 12 and 14 of the preform sheet capable of enduring predetermined internal pressure, but may leak through fine gaps at the side ends of the woven polyethylene fabric layer 13 extending in parallel with the polyethylene coating layers 12 and 14. This problematic phenomenon appears more vividly when the watering hose has a damaged surface, which has a fatal effect on the reliability of goods.

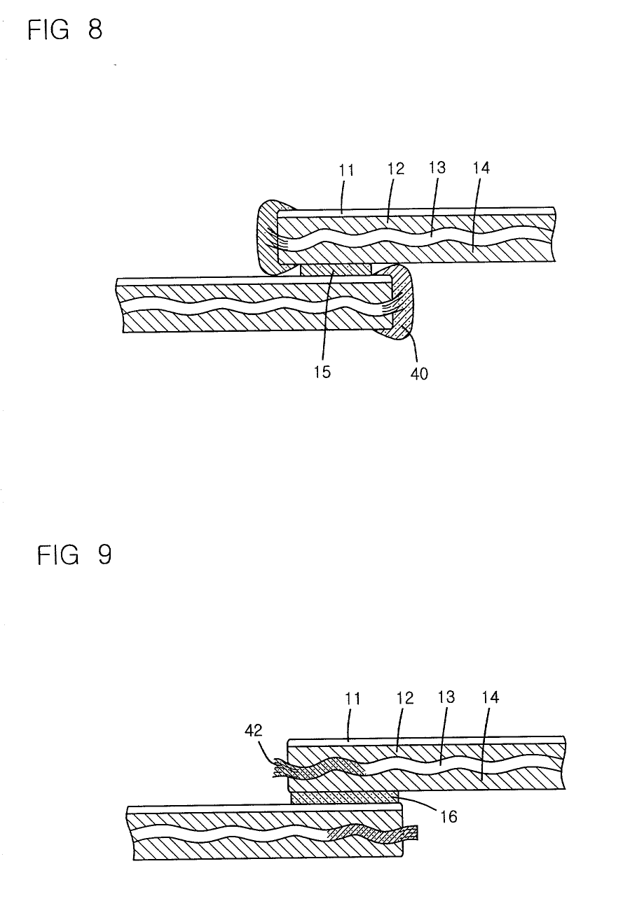

Therefore, it is preferred that a watering hose has a watertight construction formed by sealing the side ends of the woven polyethylene fabric layer 13 as shown in FIGS. 8 to 11, thereby preventing the so-called sweating phenomenon. Reference numerals 15 and 16 designate adhesive agents applied in order to attach the overlapping side ends of each preform sheet to each other.

FIG. 8 shows a preform sheet having a watertight construction for preventing the sweating phenomenon as described above, according to another embodiment of the present invention. In the preform sheet, adhesive agent 40 is coated on side ends of the preform sheet which includes a woven polyethylene fabric layer 13, polyethylene coating layers 12 and 14 covered on the woven polyethylene fabric layer 13, and a polyethylene protective film 11 coated on a surface of the polyethylene coating layer 12, so that the side ends of the preform sheet can be sufficiently sealed.

The adhesive agent 40 applied to the side ends of the preform sheet has an adhesive film construction having predetermined viscosity and surrounding side ends of the watering hose 10. In this way, the adhesive agent 40 is coated on and completely seals the side ends of the preform sheet at which the woven polyethylene fabric layer 13 may be otherwise exposed, so that leakage of water through the side ends of the preform sheet is basically prevented even when the watering hose 10 is under high internal pressure.

FIG. 9 shows a preform sheet having a watertight construction for preventing the sweating phenomenon, according to another embodiment of the present invention. In the shown preform sheet, both side ends of the woven polyethylene fabric layer 13 exposed along side ends of the preform sheet are impregnated with adhesive solution 42 which is weakly blended and easily adsorbed, so that fine gaps in the woven polyethylene fabric layer 13 are filled with the adhesive solution 42, thereby making the attached side ends of the preform sheet be watertight.

In other words, the adhesive solution 42 permeating in the gaps in the woven polyethylene fabric layer 13 exposed along the side ends of the preform sheet blocks the water passage. In order to allow the adhesive solution 42 to easily permeate into the gaps, the adhesive solution 42 should be a weakly blended one, so that the adhesive solution 42 has low viscosity.

The adhesive solution 42 as described above not only permeates into the woven polyethylene fabric layer 13 through the side ends of the preform sheet and fills up fine gaps in the woven polyethylene fabric layer 13, but also is tightly attached to the polyethylene coating layers 12 and 14 and the polyethylene protective film 11, thereby accomplishing reliable watertight attachment between the side ends of the preform sheet.

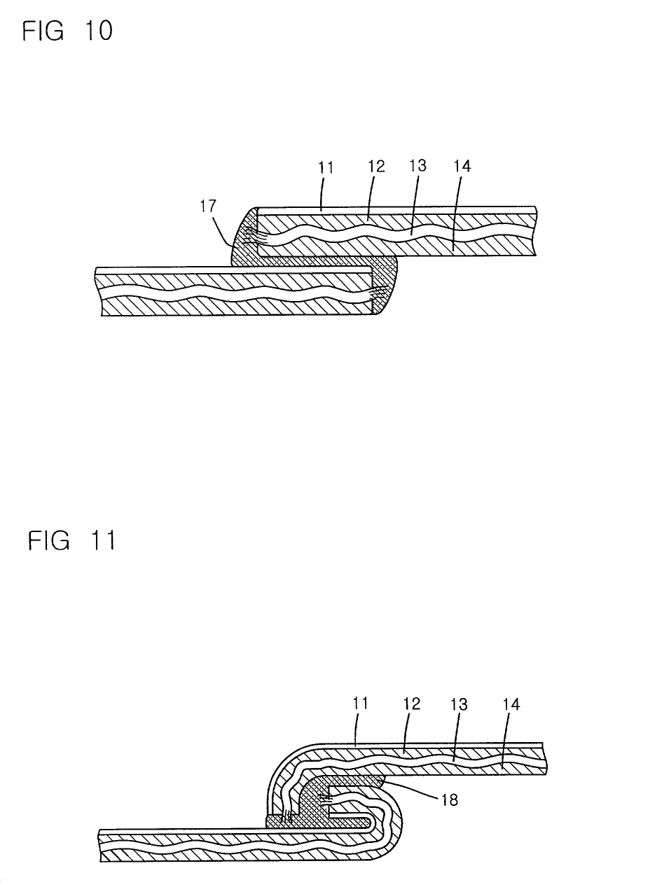

FIG. 10 shows a preform sheet according to another embodiment of the present invention, in which adhesive agent 17 is applied to and compressed between side ends of the preform sheet, thereby watertightly attaching the side ends of the preform sheet to each other.

That is, the adhesive agent 17, which is applied between overlapping surfaces of the side ends of the preform sheet in order to attach the overlapping surfaces to each other, is compressed and spread out of the overlapping surfaces to cover on the side ends by rollers, thereby watertightly attaching the side ends of the preform sheet to each other. In this case, in addition to the adhesive agent 17 applied between the overlapping surfaces, the adhesive agent 40 may be simultaneously applied as shown in FIG. 8, so as to achieve more reliable watertight attachment between the side ends of the preform sheet.

Further, FIG. 11 is a sectional view of attached side ends of a preform sheet according to another embodiment of the present invention, in which the side ends are bent in advance before being attached to each other to form a watertight construction.

As shown, between the two side ends of the preform sheet, an inner side end, which is disposed inside when the two side ends overlaps with each other, is firstly bent outward to form a bent side end of the preform sheet. Then, the bent side end is overlapped with and attached to the other side end of the preform sheet by means of adhesive agent 18, so that the polyethylene coating layer 12 and the polyethylene protective film 11 covering the inner surface of the woven polyethylene fabric layer 13 can provide the watertight effect.

That is, in the bent side end of the preform sheet which is bent outward in advance, the polyethylene protective film 11 forms the inner surface of the bent side end. Therefore, when the bent side end is overlapped with and attached to the other side end of the preform sheet by means of the adhesive agent 18, only the polyethylene protective film 11 is exposed but the woven polyethylene fabric layer 13 is completely covered by the polyethylene protective film 11 at the interior of the watering hose, so as to prevent the sweating phenomenon through the woven polyethylene fabric layer 13.

Further, as shown in FIGS. 12 to 15, a resin film strip may be directly attached to an exposed inner side end of the preform sheet, which is disposed at the inner side when the two side ends of the preform sheet are overlapped on and attached to each other, so as to watertightly seal the inner side end, thereby preventing the sweating phenomenon.

FIG. 12A is a transverse sectional view of a preform sheet for forming a watering hose according to another embodiment of the present invention, in which a resin film strip is attached to an exposed inner side end of the preform sheet, and FIG. 12B is a transverse sectional view of the watering hose made of the preform sheet.

That is, as shown in FIG. 12A, a resin film 45 shaped like a belt is firstly attached along a side portion of one side end of the preform sheet, which will form a portion of an inner surface of the watering hose 10. Thereafter, the side ends of the preform sheet are overlapped on and attached to each other while the resin film 45 is attached to an inner side portion of the other side end of the preform sheet. Then, as shown in FIG. 12B, the inner side end of the watering hose 10 is watertightly covered with the resin film 45, so as to prevent the sweating phenomenon through the woven polyethylene fabric layer which is a component of the watering hose 10.

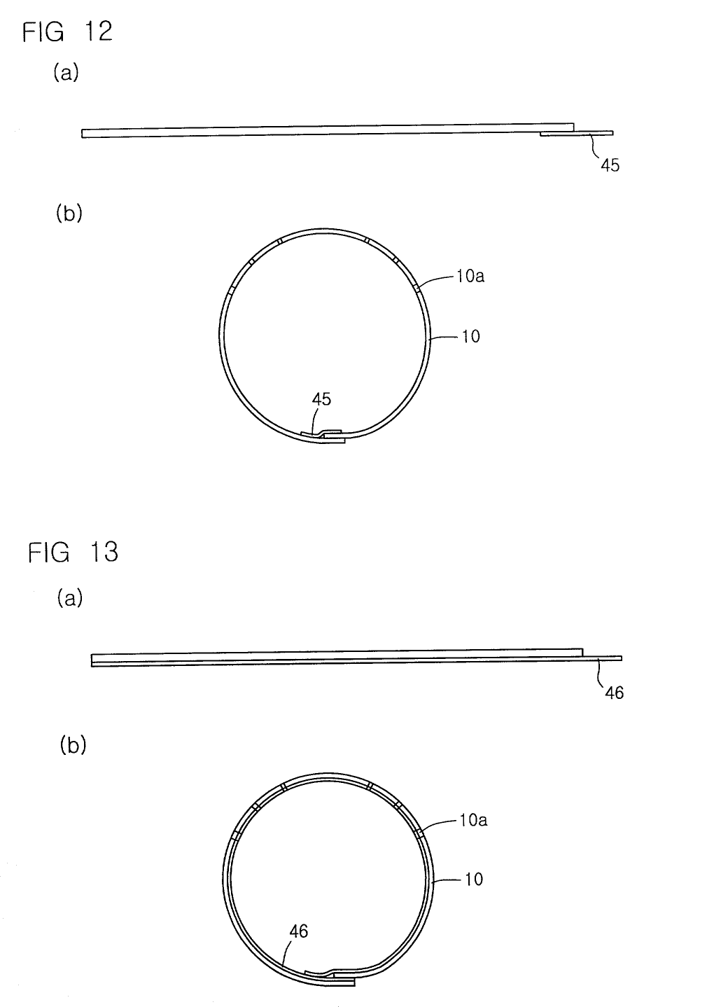

FIGS. 13A and 13B are transverse sectional views of a preform sheet and a watering hose made of the preform sheet, according to another embodiment of the present invention, which show an attachment construction of a resin film 46 different from the resin film strip in FIGS. 12A and 12B.

As shown in FIG. 13A, the resin film 46 covers on and is attached to the entire inner surface of a preform sheet, which will form an inner surface of the watering hose 10, while a portion of the resin film 46 protrudes beyond the exposed inner side end of the watering hose 10. From this state, side ends of the preform sheet having the construction described above are overlapped on and attached to each other in the same manner as that in FIG. 12B. Then, as shown in FIG. 13B, the exposed inner side end of the watering hose 10 is watertightly covered by the resin film 46, so as to prevent the sweating phenomenon. Moreover, stepped portion formed on the inner surface of the watering hose 10 is minimized, so as to minimize the frictional force to the water flowing through the watering hose 10.

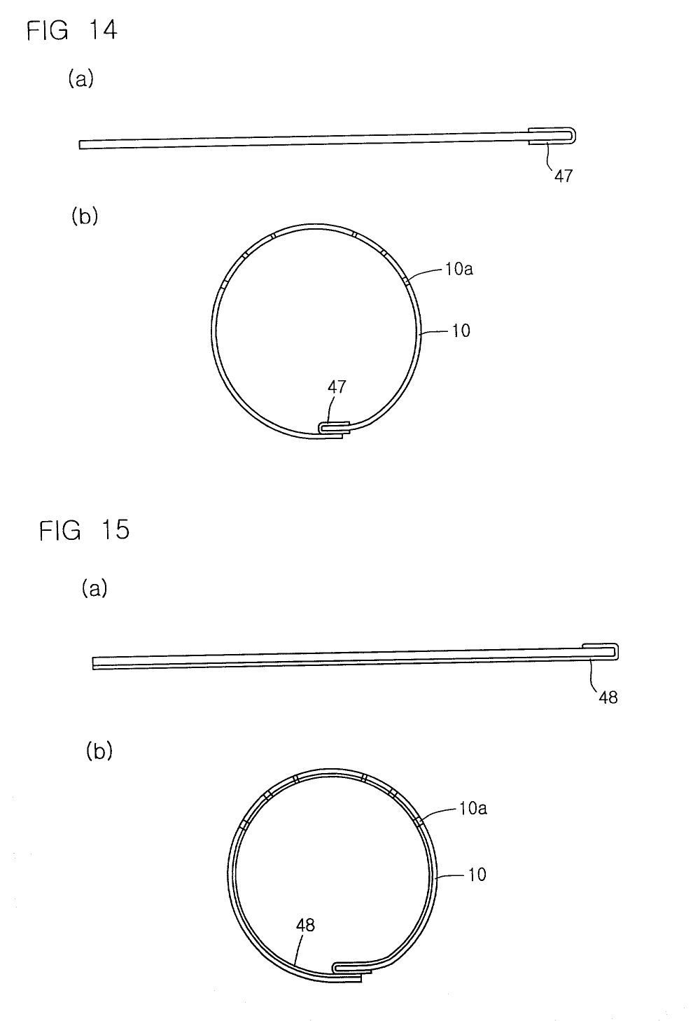

FIGS. 14A and 14B are transverse sectional views of a preform sheet and a watering hose made of the preform sheet, according to another embodiment of the present invention, which show another attachment construction of a resin film.

That is, a resin film 47 shaped like a belt, which is watertightening means according to another embodiment of the present invention, is attached in such a manner that the resin film 47 surrounds the exposed inner side end of the watering hose 10 as shown in FIG. 14A. In this state, the side ends of the preform sheet are overlapped on and attached to each other. Then, as shown in FIG. 14B, the side ends are attached to each other while the inner side end of the watering hose 10 is sealed by the resin film 47, so as to form a watertight construction, thereby preventing the sweating phenomenon through the woven polyethylene fabric layer which is a component of the watering hose 10.

FIGS. 15A and 15B are transverse sectional views of a preform sheet and a watering hose made of the preform sheet, according to another embodiment of the present invention, which show an attachment construction of a resin film 48 different from the resin film strip in FIGS. 14A and 14B.

As shown in FIG. 15A, the resin film 48 covers on and is attached to the entire inner surface of a preform sheet, which will form an inner surface of the watering hose 10, while a portion of the resin film 48 protrudes beyond and surrounds the exposed inner side end of the watering hose 10 and is attached to the other surface of the preform sheet. From this state, side ends of the preform sheet having the construction described above are overlapped on and attached to each other in the same manner as that in FIG. 14B. Then, as shown in FIG. 15B, the exposed inner side end of the watering hose 10 is watertightly covered by the resin film 48, so as to prevent the sweating phenomenon. Moreover, stepped portion formed on the inner surface of the watering hose 10 is minimized, so as to minimize the frictional force to the water flowing through the watering hose 10.

As the resin films 45 to 48 for watertightening the exposed inner side end of the watering hose 10, hard resin films such as a high density polyethylene (HDPE) film, a biaxially oriented polypropylene (BOPP) film, and a polyethylene terephthalate (PET) film, or soft resin films such as a low density polyethylene (LDPE) film, a casting polypropylene (CPP) film, a thermoplastic elastomer film, and a silicon film may be employed.

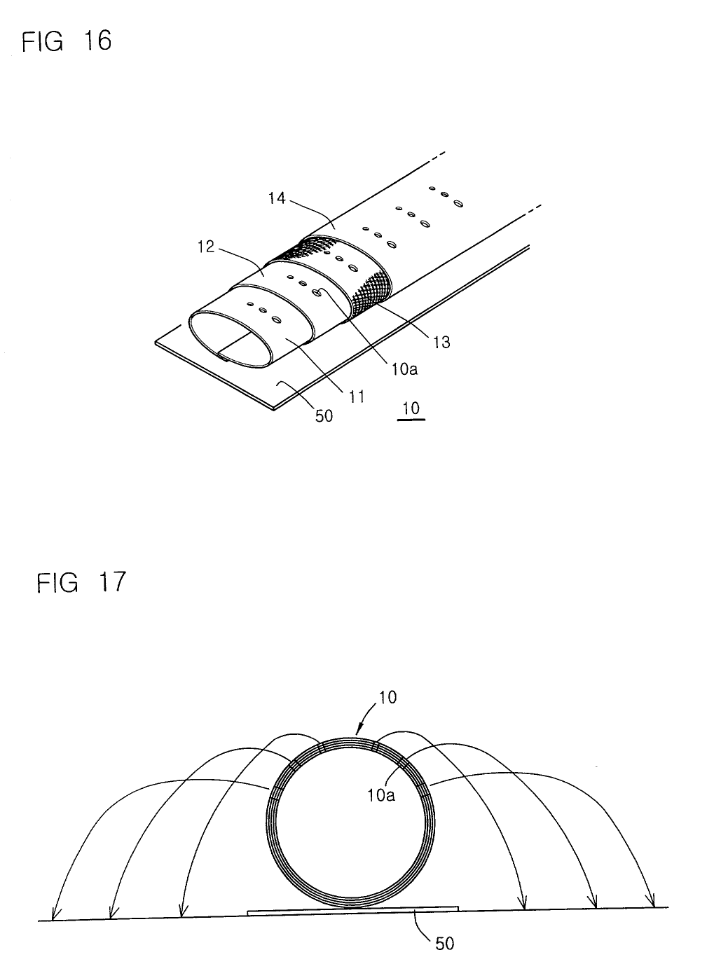

FIG. 16 is a partly cut-out perspective view of a watering hose according to another embodiment of the present invention, in which a seating member 50 is attached to one surface of the watering hose 10. The seating member 50 is made from resin, has a shape of an elongated plate with a uniform width, and forms a flat bottom of the watering hose.

That is, a portion of the outer surface of the watering hose 10 is attached along a longitudinal center portion of the watering hose 10, so that the flat bottom is formed along one side of the watering hose 10.

Since the seating member 50 attached longitudinally along a portion of the watering hose 10 forms a flat bottom of the watering hose as described above and is placed on the ground to support the entire watering hose, the watering hose 10 is efficiently prevented from twisting or shaking even when water of high pressure is transferred through the watering hose.

Meanwhile, it is preferred that the seating member 50 is made from resin having a high hardness, such as hard resin, polyethylene tarpaulin, polypropylene tarpaulin, or resin complex in which hard resin and soft resin are mixed or laminated, so that the seating member 50 is not twisted or bent but can maintain its flat shape while water is transferred through the watering hose 10, thereby stably supporting the watering hose 10.

The soft resin has a large ductility and provides the watering hose 10 with a property which enables the watering hose 10 to be smoothly bent, while the hard resin has a large hardness and provides the seating member 50 with a property which enables the seating member 50 to maintain its original shape. Therefore, when the seating member 50 is made of multiple resin films including hard resin films and soft resin films overlapped on each other, there can be produced a watering hose which is light so that it can be easily managed and installed and has an excellent ability of maintaining its shape while it is flexible.

As the hard resin film, a high density polyethylene (HDPE), a biaxially oriented polypropylene (BOPP) film, or a polyethylene terephthalate (PET) film may be utilized.

The high density polyethylene (HDPE) film is made from hard polyethylene whose density is about 0.941 to 0.965 g/cm², and has a tensile strength of 330 to 340 kg/cm², which is 2.5 times as large as that of the low density polyethylene, that is, the high density polyethylene has nearly the same rupture-resistance as that of the woven polyethylene fabric layer. The biaxially oriented polypropylene (BOPP) film is a film formed by biaxially orienting polypropylene in transverse and longitudinal directions. The biaxially oriented polypropylene (BOPP) film has superior tensile strength and impact strength, and has a strong film surface, so that the film surface is not easily scarred by friction. Further, the polyethylene terephthalate film is formed by melting and compressing PET chip polymer and then orienting the film in transverse and longitudinal directions. The polyethylene terephthalate film has the largest strength among general plastic and has a superior heat-resistance.

As the soft resin film, a low density polyethylene (LDPE) film, a casting polypropylene (CPP) film, a thermoplastic elastomer film, and a silicon film may be employed.

The low density polyethylene film is made from soft polyethylene whose density is about 0.91 g/cm², and has a crystallized portion of 65%. Therefore, the low density polyethylene film (LDPE) is spread well and has a good flexibility, has a high impact-resistance while it has a small tensile strength, and can be easily machined. The casting polypropylene (CPP) film is a film, in which polypropylene is not oriented. The casting polypropylene film not only is flexible but also has excellent transparence and luster and shows a superior property in printing. Further, the thermoplastic elastomer (TPE) film has a construction in which hard polymeric material and soft polymeric material are combined, and shows the elasticity of rubber at normal temperature, so as to remarkably improve the flexibility of the watering hose.

FIG. 17 is a side sectional view of the watering hose shown in FIG. 16. As shown, the spray apertures 10a formed through the tubular body of the watering hose have diameters different in the circumferential direction, so that water can be sprayed through the different spray apertures 10a at different pressures, thereby enabling the water to be evenly distributed in a broad area.

In this case, since the watering hose according to the present invention is placed on the ground, it is preferred that, the lower the spray aperture is located, the larger the diameter of the spray aperture is. In result, water can be sprayed at higher pressure through the lower spray apertures than that of the water through the higher spray apertures, so that water through the lower spray apertures can be distributed in a farther area. That is, water sprayed through the spray apertures 10a can be evenly distributed in a broad area without mutual interference.

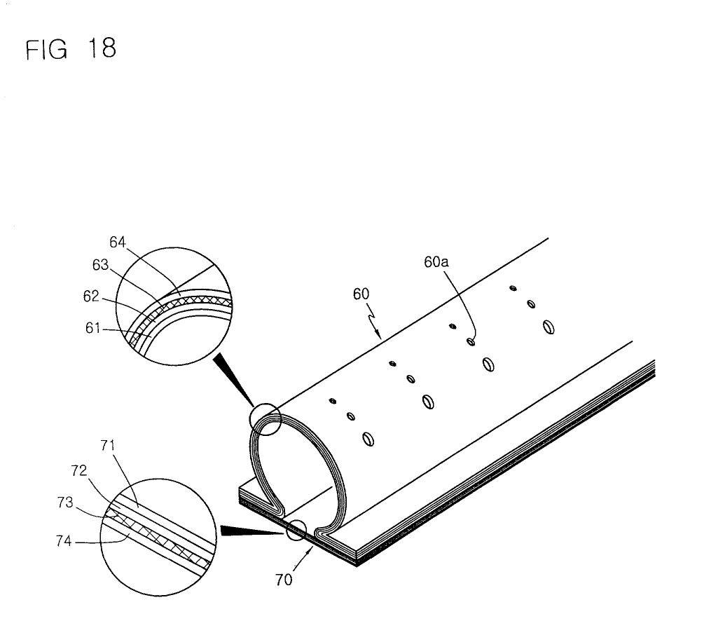

FIG. 18 is a perspective view of a watering hose according to another embodiment of the present invention. As shown, the watering hose includes a tubing member 60 and a bottom plate 70. In this case, the tubing member 60 and the bottom plate 70 respectively include a polyethylene protective film 61 and 71, a polyethylene coating layer 62 and 72, a woven polyethylene fabric layer 63 and 73, and a polyethylene coating layer 64 and 74, which are overlapped on and attached to each other.

Each of the tubing member 60 and the bottom plate 70 is made of a preform sheet according to the present invention, which is shaped like a belt having a uniform width, while the width of the tubing member 60 is larger than that of the bottom plate 70. Further, side portions of the tubing member 60 are attached to side portions of the bottom plate 70 while a central portion of the tubing member 60 rises in tubular shape, so as to form a watering hose having a fluid channel between the tubing member 60 and the bottom plate 70.

In the watering hose having the construction described above, the bottom plate 70 forming an outer surface of the watering hose serves as a seating member for the watering hose. The seating member is placed on the ground to support the entire watering hose, so that the watering hose is efficiently prevented from twisting or shaking even when water of high pressure is transferred through the watering hose.

As apparent from the above embodiments described above, the watering hose according to the present invention is a made of a preform sheet having polyethylene multi-layers including a woven polyethylene fabric layer. Therefore, the watering hose can be efficiently used in transferring and spraying water of high pressure while the watering hose is very thin, thereby reducing cost of material, improving flexibility of the watering hose, simplifying and facilitating the process of forming the watering hose, and improving the productivity.

Further, in the watering hose according to the present invention, exposed side ends of the woven polyethylene fabric layer are coated with adhesive agent so as to be watertight ends, thereby preventing the so-called sweating phenomenon in which water leaks through the woven polyethylene fabric layer.

Further, in the watering hose having a woven polyethylene fabric layer according to the present invention, a flat seating member is formed along a portion of a tubular body of the watering hose, so as to prevent the watering hose from moving even without a separate fixing member and simplify the labor of installing the watering hose on a field to be watered.

Furthermore, in the watering hose having a woven polyethylene fabric layer according to the present invention, spray apertures whose sizes are different in the circumferential direction are formed through the watering hose, so that water is sprayed through the different spray apertures at different pressures, thereby enabling a small number of watering hoses to evenly water a broad area.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A watering hose having a plurality of spray apertures formed through a tubular body of the watering hose, the watering hose being made by overlapping and attaching side ends of a preform sheet on and to each other, the preform sheet having polyethylene multi-layers, the polyethylene multi-layers comprising at least one woven polyethylene fabric layer and polyethylene coating layers, the polyethylene coating layers forming both outer surfaces of the polyethylene multi-layers.

2. A watering hose as claimed in claim 1, wherein the preform sheet further comprising a polyethylene protective film overlapped on and attached to the polyethylene multi-layers, the polyethylene protective film serving as an inner surface of the watering hose.

3. A watering hose as claimed in claim 1 or claim 2, wherein the polyethylene multi-layers comprise at least one woven polyethylene fabric layer and a plurality of polyethylene coating layers, which are alternately overlapped on and attached to each other, the polyethylene coating layers forming both outer surfaces of the polyethylene multi-layers.

4. A watering hose as claimed in claim 1 or claim 2, wherein the polyethylene multi-layers comprise a plurality of tarpaulin layers between which a watertight bonding film is interposed, each of the tarpaulin layers including a woven polyethylene fabric layer and two polyethylene coating layers overlapped and attached to the woven polyethylene fabric layer.

5. A watering hose as claimed in claim 1 or claim 2, wherein the side ends of the preform sheet are coated with adhesive agent, so that side ends of the woven polyethylene fabric layer are covered by the adhesive agent and the side ends of the preform sheet become watertight ends.

6. A watering hose as claimed in claim 5, wherein the adhesive agent is applied in such a manner as to surround the side ends of the preform sheet.

7. A watering hose as claimed in claim 5, wherein the side ends of the preform sheet are impregnated with adhesive solution which is weakly blended, so that the adhesive solution permeates into the side ends of the woven polyethylene fabric layer, thereby blocking the side ends of the woven polyethylene fabric layer.

8. A watering hose as claimed in claim 5, wherein the adhesive agent is applied between the side ends of the preform sheet, and is compressed and spread out of the overlapping surfaces to cover on the side ends of the preform sheet, thereby watertightly attaching the side ends of the preform sheet to each other.

9. A watering hose as claimed in claim 5, wherein an inner side end of the preform sheet, which is disposed inside when the two side ends overlaps with each other, is firstly bent outward to form a bent side end of the preform sheet, and then the bent side end is overlapped with and attached to an other side end of the preform sheet by means of the adhesive agent, so that the polyethylene coating layer of the polyethylene multi-layers performs a watertight function.

10. A watering hose as claimed in claim 1 or claim 2, wherein an inner side end of the preform sheet, which is disposed inside when the two side ends overlaps with each other, is watertightly covered by a resin film.

11. A watering hose as claimed in claim 10, wherein the resin film is attached to one surface of the preform sheet and has one end protruding beyond the inner side end of the preform sheet, said one surface of the preform sheet serving as the inner surface of the watering hose.

12. A watering hose as claimed in claim 11, wherein the resin film entirely covers and is attached to one surface of the preform sheet, and has one end protruding beyond the inner side end of the preform sheet, the resin film serving as the inner surface of the watering hose.

13. A watering hose as claimed in claim 10, wherein the resin film is attached so as to surround the inner side end of the preform sheet.

14. A watering hose as claimed in claim 13, wherein the resin film entirely covers and is attached to one surface of the preform sheet, the resin film surrounding the inner side end of the preform sheet, the resin film serving as the inner surface of the watering hose.

15. A watering hose as claimed in claim 1 or claim 2, the watering hose further comprising a flat member formed at a portion of the tubular body of the watering hose, the flat member extending in a longitudinal direction of the watering hose.

16. A watering hose as claimed in claim 15, wherein the flat member comprises a seating member which has a shape of an elongated plate with a uniform width and forms a flat bottom of the watering hose to support the tubular body of the watering hose.

17. A watering hose as claimed in claim 16, wherein the flat member is made from one selected from the group consisting of hard resin, polyethylene tarpaulin, polypropylene tarpaulin, and resin complex in which hard resin and soft resin are overlapped.

18. A watering hose as claimed in claim 15, wherein the spray apertures formed through a tubular body of the watering hose have diameters which are different according to circumferential locations of the spray apertures.

19. A watering hose as claimed in claim 18, wherein each of the spray apertures has a diameter larger than that of another spray aperture which is located higher than said each of the spray apertures.

20. A watering hose having a plurality of spray apertures formed through a tubular body of the watering hose, the watering hose comprising a tubing member and a bottom plate, each of the tubing member and the bottom plate having polyethylene multi-layers which comprises a woven polyethylene fabric layer, two polyethylene coating layers overlapped on and attached to the woven polyethylene fabric layer, and a polyethylene protective film overlapped on and attached to one of the two polyethylene coating layers, the tubing member having a width larger than that of the bottom plate, side portions of the tubing member being attached to side portions of the bottom plate so that a central portion of the tubing member rises in tubular shape and the polyethylene protective film forms an inner surface of the watering hose, so as to form a fluid channel between the tubing member and the bottom plate.
